(19) United States
(12) Patent Application Publication
(10) Pub. No.: US 2020/0323168 A1
(43) Pub. Date: Oct. 15, 2020

(54) PET-ONLY FEEDER

(71) Applicant: ELDON LEONARD STROBURG, BLOCKTON, IA (US)

(72) Inventor: ELDON LEONARD STROBURG, BLOCKTON, IA (US)

(21) Appl. No.: 16/382,329

(22) Filed: Apr. 12, 2019

(51) Int. Cl. A01K 5/01; A01K 5/02; G06K 9/00

(52) U.S. Cl. CPC A01K 5/0142; G06K 9/00362; A01K 5/02

(57) ABSTRACT

A pet-only feeder may include a facial recognition device that triggers the opening of a lid so that a pet can eat when the pet appears in front of the facial recognition device.

### FIELD OF THE INVENTION

The invention relates generally to the field of feeders for pets. The invention relates more specifically to feeders for pets that open with a facial recognition device.

### BACKGROUND

Pet feeders can have various designs. Pet feeders can have a problem with the wrong animal eating from a pet feeder. Accordingly, there is a need for a new and improved pet feeder.

### SUMMARY OF INVENTION

According to an exemplary embodiment of the invention, a pet-only feeder may comprise: a food storage bin; a first lid attached to a top of the food storage bin; a second lid attached to a front portion of the food storage bin; a facial recognition device attached to a side of the food storage bin; a solenoid attached by electric wires to the facial recognition device; wherein in response to the facial recognition device recognizing a pet appearing in front of the facial recognition device, the facial recognition device triggers the solenoid, wherein the triggered solenoid rotates the second lid into an open position, thereby allowing the pet to eat from the food storage bin.

### DESCRIPTION OF THE FIGURES

FIG. 1 shows a top view of an embodiment of the invention.

FIG. 2 shows a front view of the embodiment of the invention from FIG. 1.

FIG. 3 shows a left hand side view of the invention of FIG. 1.

### DETAILED DESCRIPTION

The following description is not intended to limit the scope of the invention, but to generally illustrate the invention. The invention belongs to the field of pet feeders.

Below are descriptions of the number elements in the Figures.
1—lid to food storage bin
2—food storage bin
3—electric solenoid to open lid
4—lid in open position for pet to eat
5—lid where pets eat in closed position
6—facial recognition device
7—first wire
8—second wire
9—pet
10—pet only feeder

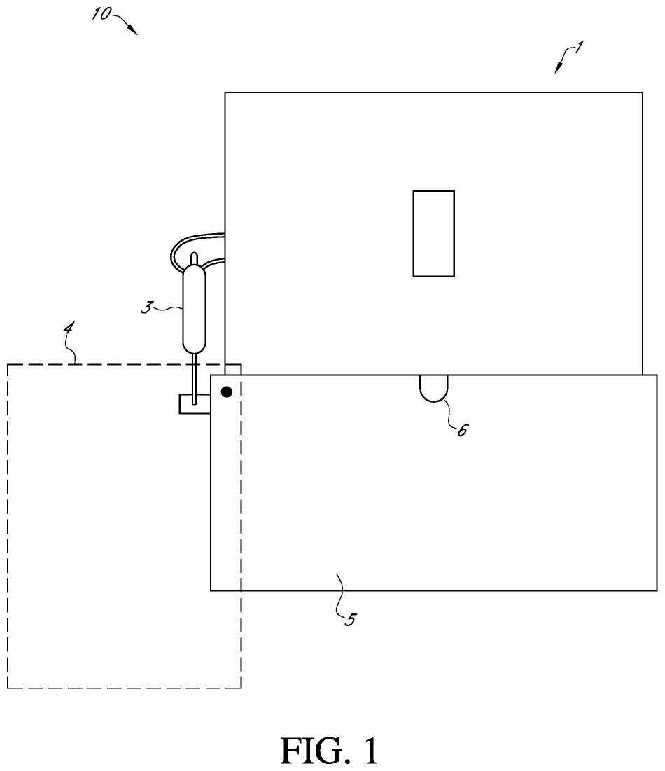

As shown in FIG. 1, a preferred embodiment exemplifying a best mode of a pet-only feeder (10) can include a food storage bin lid (1), an electric solenoid (3) to open a lid (5) where pets eat shown in a closed position. Shown at (4) is the lid (5) where pets eat in an open position.

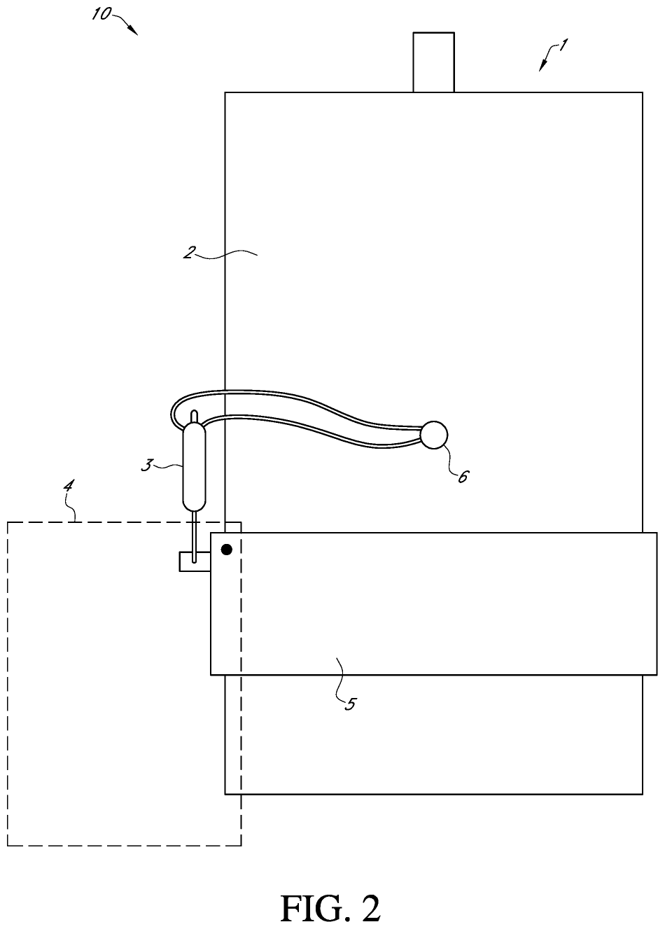

As shown in FIG. 2, the pet-only feeder (10) can include the food storage bin lid (1), the food storage bin (2), the electric solenoid (3), the lid (5) where pets eat, and a facial recognition device (6). Shown at (4) is the lid (5) where pets eat in an open position.

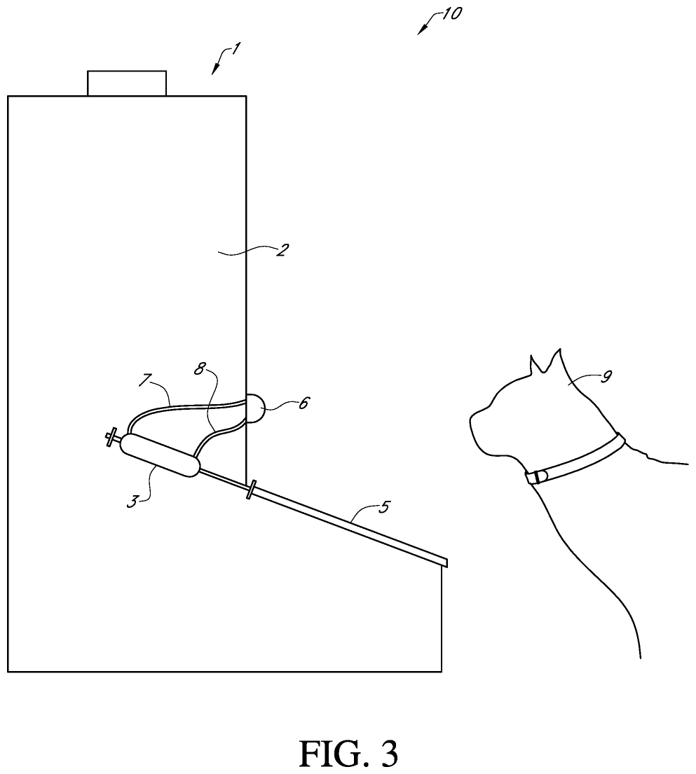

As shown in FIG. 3, the pet-only feeder (10) can include the food storage bin lid (1), the food storage bin (2), the electric solenoid (3), the lid (5) where pets eat shown in a closed position, the facial recognition device (6), and wires (7,8) between the electric solenoid (3) and the facial recognition device (6).

In an embodiment, when a pet (9) (see FIG. 3), appears in front of the facial recognition device (6), the facial recognition device triggers the electric solenoid (3) through the electric wires (7, 8), to rotate the lid where pets eat (5) into an open position (4).

In an embodiment, when a pet (9) (See FIG. 3), leaves the front of the facial recognition device (6), the facial recognition device (6) no longer triggers the electric solenoid (3) through the electric wires (7,8), to rotate the lid where pets eat (5), so the lid where pets eat (5) moves back into a closed position (See (5) in FIGS. 1, 2, and 3).

In an embodiment, the facial recognition device (6) can recognize a person's pet from an animal that is not the persons pet, thereby only opening the lid (5) where pets eat in response to the person's pet appearing in front of the facial recognition device (6). Therefore, the lid (5) where pets eat remains closed when the animal that is not the person's pet appears in front of the facial recognition device.

In an embodiment, the electric solenoid (3) may be positioned to rotate the lid where pets eat (5) sideways at a right angle to the food storage bin (2) into the shown lid in open position (4). In another embodiment, the electric solenoid (3) may be positioned to rotate the lid (5) where pets eat upwards.

The invention can be made of any suitable material including but not limited to, cloth products, plastic products, rubber products, and other natural or human made materials.

The above description can be modified without departing from the scope of the claims below.

1. A pet-only feeder, comprising:
a food storage bin;
a first lid attached to a top of the food storage bin;
a second lid attached to a front portion of the food storage bin;
a facial recognition device attached to a side of the food storage bin, wherein the facial recognition device is capable of distinguishing a person's pet from an animal that is not the person's pet;
a solenoid attached by electric wires to the facial recognition device;
wherein in response to the facial recognition device recognizing the person's pet appearing in front of the facial recognition device, the facial recognition device triggers the solenoid, wherein the triggered solenoid rotates the second lid sideways at a right angle to the food storage bin into an open position, thereby allowing the person's pet to eat from the food storage bin,
wherein the food storage bin extends from the first lid to the second lid.
